(19) United States
(12) Patent Application Publication
(10) Pub. No.: US 2012/0194742 A1
(43) Pub. Date: Aug. 2, 2012

(54) SYSTEM AND METHOD FOR DISPLAYING INTERACTIVE INFORMATION

(75) Inventors: Tracy Barnes, San Diego, CA (US); Hyehoon Yi, Escondido, CA (US)

(73) Assignee: SONY CORPORATION, Tokyo (JP)

(21) Appl. No.: 13/015,429

(22) Filed: Jan. 27, 2011

(51) Int. Cl. H04N 5/50; H04N 5/445

(52) U.S. Cl. 348/569; 348/563; 348/E05.097; 348/E05.099

(57) ABSTRACT

A system and method for interactively presenting content related information to facilitate user setting modification. The method includes accessing content from a content source which comprises a plurality of information associated with the content and displaying a banner comprising a portion of the plurality of information. A piece of the plurality of information associated with the content is selectable by the user via on-screen elements. The method further includes receiving a selection of the piece of information of the plurality of information associated with the content and performing a function associated with the piece of information of the plurality of information associated with the content, e.g., modifying a television setting related to the selected information.

### RELATED U.S. APPLICATIONS

This application is related to co-pending U.S. patent application Ser. No. 12/886,454, Attorney Docket Number SONY-200902835.02, entitled “METHOD AND SYSTEM OF DISPLAYING INFORMATION OF SPECIFIC INTEREST TO A USER ON A TELEVISION,” with filing date Sep. 20, 2010, and hereby incorporated by reference in its entirety.

### FIELD OF THE INVENTION

Embodiments of the present invention are generally related to display of information in an interactive manner, e.g., related to an audio/video system.

### BACKGROUND OF THE INVENTION

As televisions have advanced, televisions have supported an increasing number of functions and an increasing number of different types of content. The different types of content also include information about the content. A banner or information area is often presented with the content when the content begins being displayed or in response to an information button being pressed. The banner may display static information based on the information about the content contained in the content stream. For example, the banner may indicate the title of the show, a description of the show, and the rating, etc. Often times, the information presented in the banner is associated with a setting of the television.

While this information is supposed to be useful to a viewer, often times the viewer does not understand the information or how to use it. For example, the viewer may be presented with an indication that there is a closed captioning stream but the closed captioning stream can only be accessed by entering the television settings menu and going to the closed captioning settings area. This may be particularly difficult for the viewer as he or she may not be familiar with the various settings menus and therefore it may take the viewer quite some time to enable the closed captioning. In addition, if there are multiple closed captioning streams, the viewer may select the wrong one and have to enter the settings menus again to attempt to select the desired closed captioning stream. Often the banner information may also include icons or technical words that the user may not be familiar with.

Thus, the information presented in the banner is often of little use to a viewer or requires the viewer to go into the settings menu items which are often unfamiliar and difficult for the viewer to navigate and use.

### SUMMARY OF THE INVENTION

Thus, a need exists for user friendly access to content rendering settings, e.g., in an intuitive manner for a viewer. Embodiments of the present invention provide an interactive banner with information related to the content which is selectable to thereby access functions associated with the information related to the content. Easy access is thus provided to display device settings and other content rendering settings without the viewer having to enter and navigate complex and general menus. Embodiments of the present invention further eliminate the need for direct access remote control keys because functions are available via the interactive banner. Embodiments of the present invention also provide a more consistent user expectation for where to perform settings changes instead of the user having to determine which button to press on a remote control.

In one embodiment, the present invention is implemented as a method for interactively presenting content related information. The method includes accessing content from a content source, which comprises a plurality of information associated with the content, and displaying a banner comprising a portion of the plurality of information. A piece of the plurality of information associated with the content is selectable. The banner may overlay the content during playback and may be automatically displayed upon accessing the content. The method further includes receiving a selection of the piece of information of the plurality of information associated with the content and performing a function associated with the piece of information of the plurality of information associated with the content. The function may be operable to store a channel as a favorite, display a list of a plurality of channels, display a list of a plurality of inputs, display a list of a plurality of closed captioning streams, and allow selection of one of a plurality of audio streams. The each of the plurality of inputs and each of the plurality of closed captioning streams may be selectable.

In one embodiment, the present invention is implemented as a system for interactive presentation of content related information. The system includes a content information access module operable to access information associated with a piece of content and a content information display module operable to the display the information associated with the piece of content. The content information display module can display the information associated with the piece of content in a banner. The system further includes a content information selection module operable to receive a selection of information associated with the piece of content and a content information selection processing module operable to perform a function associated with the selection of information associated with the piece of content. The function may be operable for receiving a selection of one of a plurality of display device inputs, receiving a selection of one of a plurality of channels, receiving a selection of a parental rating threshold, and receiving a selection of a configuration menu.

In another embodiment, the present invention is implemented as a computer readable media comprising instructions that when executed by an electronic system implement a method for interactively displaying content related information. The method includes accessing content from a content source, which comprises a plurality of information associated with the content, and displaying a banner comprising a portion of the plurality of information. A piece of the plurality of information associated with the content is selectable. The banner may overlay the content during playback and may be automatically displayed upon accessing the content. The method further includes receiving a selection of the piece of information of the plurality of information associated with the content and performing a function associated with the piece of information of the plurality of information associated with the content. The function may be operable to store a channel as a favorite, display a list of a plurality of channels, display a list of a plurality of inputs, display a list of a plurality of closed captioning streams, and allow selection of one of a plurality of audio streams. The each of the plurality of inputs and each of the plurality of closed captioning streams may be selectable.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a diagram of an exemplary screen display area in accordance with one embodiment of the present invention.

FIG. 2 shows exemplary components of an on-screen input menu in accordance with one embodiment of the present invention.

FIG. 3 shows exemplary components of an on-screen channel menu in accordance with one embodiment of the present invention.

FIG. 4 shows exemplary components of an on-screen menu for selecting additional menus in accordance with one embodiment of the present invention.

FIG. 5 shows exemplary components of an audio/video display device in accordance with one embodiment of the present invention.

FIG. 6 shows exemplary components of an operating environment for presenting interactive information in accordance with one embodiment of the present invention.

FIG. 7 shows a flowchart of an exemplary computer controlled process for presenting interactive information in accordance with one embodiment of the present invention.

FIGS. 8A, 8B, 9A, 9B, 10A, 10B, 10C, 11A, 11B, and 11C show exemplary on-screen display areas, in accordance with an embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

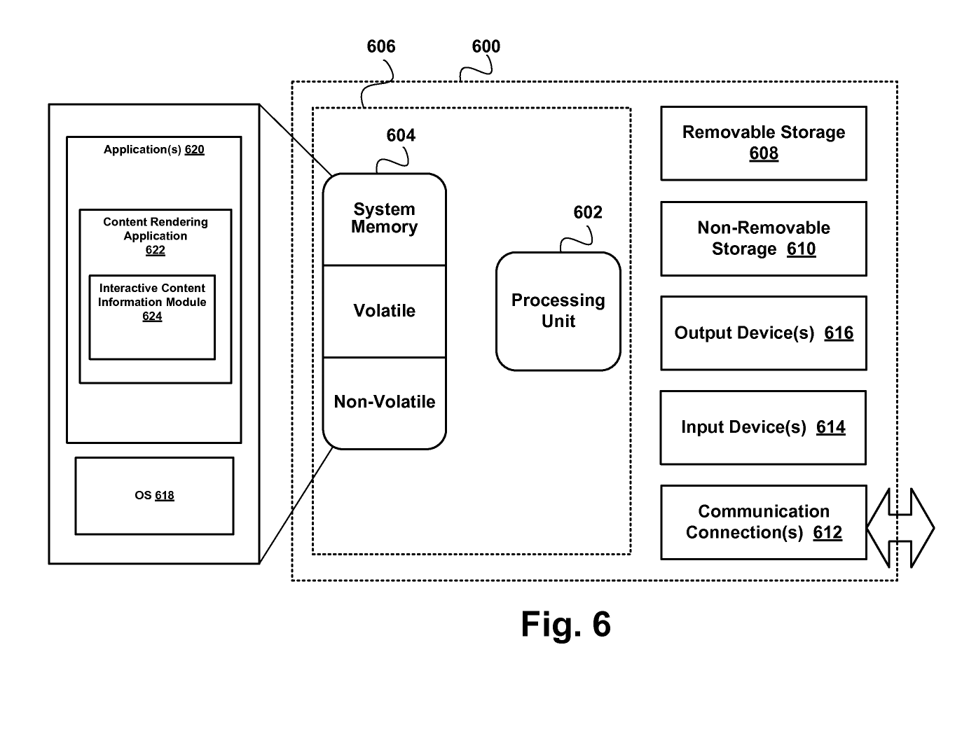

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a system having computing functionality (e.g., system 600 of FIG. 6), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods for Displaying Interactive Information

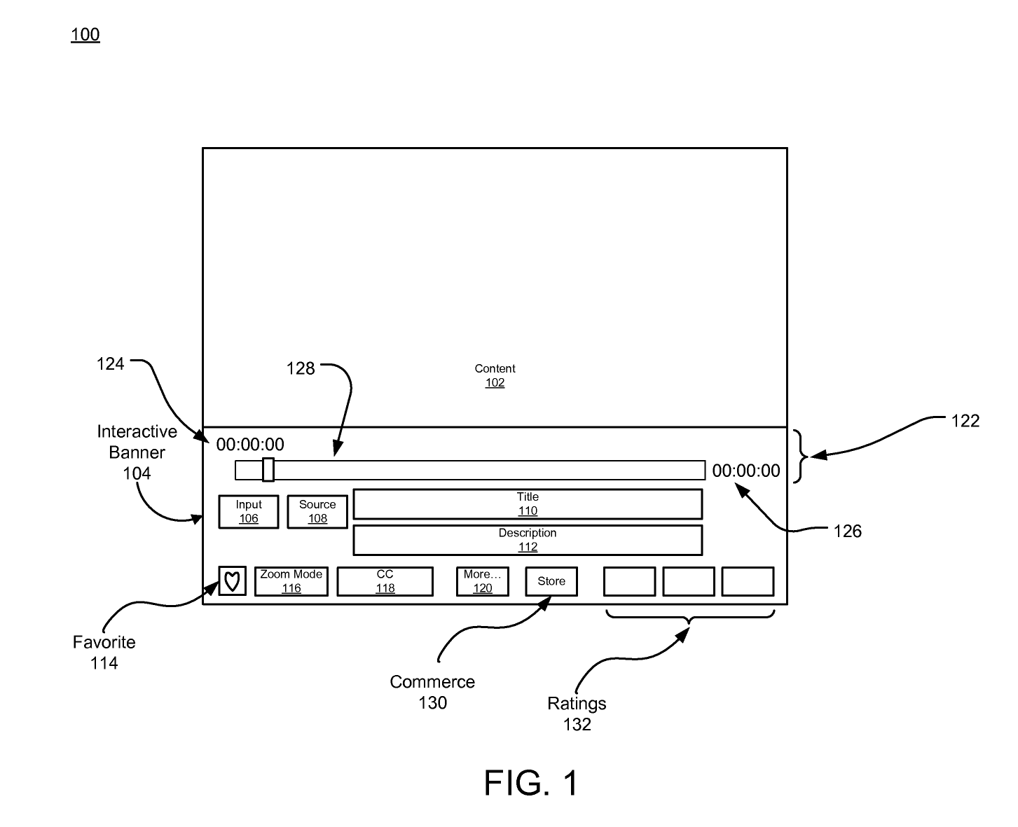

FIGS. 1-6 illustrate exemplary components used by various embodiments of the present invention. Although specific components are disclosed in systems 100-600 it should be appreciated that such components are examples. That is, embodiments of the present invention are well suited to having various other components or variations of the components recited in systems 100-600. It is appreciated that the components in systems 100-600 may operate with other components than other those presented, and that not all of the components of systems 100-600 may be required to achieve the goals of systems 100-600.

FIG. 1 shows a diagram of an on-screen exemplary display area in accordance with one embodiment of the present invention. Exemplary display area 100 resides on a media display, e.g., a television display, and includes content area 102 and interactive banner 104. Embodiments allow users to interact with information in interactive banner 104 and thereby directly change settings of the display device or other content rendering without having to enter complex menus to accomplish the setting or content change.

Content area 102 may display content from a variety of sources including computers, computer networks, portable devices, set-top boxes, over the air broadcasts, cable broadcasts, satellite broadcasts, Digital versatile Discs (DVDs), Blu-ray discs, Digital Video Broadcasting—Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc.

Interactive banner 104 may be displayed upon content being accessed, during content viewing (e.g., starting content playback or when a command is received), or upon a command from a user (e.g., via an information button on a remote control). In one embodiment, interactive banner 104 overlays content area 102. In another embodiment, content area 102 is scaled such that content area 102 is fully displayed while interactive banner 104 is displayed. Interactive banner 104 includes information associated with content operable to be displayed in content area 102 and includes items operable to control content rendering, and items operable to change settings of the device displaying display area 100.

In one exemplary embodiment, interactive banner 104 includes input area 106, source area 108, title area 110, description area 112, favorite marking area 114, zoom mode area 116, closed captioning area 118, more button 120, progress bar 122, commerce area 120, and ratings area 132. Progress bar 122 includes progress indicator 128, elapsed time indicator 124, and remaining time indicator 126. Progress indicator 128 indicates the current position in the content. Elapsed time indicator 124 indicates the amount of time relative to the beginning of the content. Remaining time indicator 126 indicates the amount of time remaining for content playback.

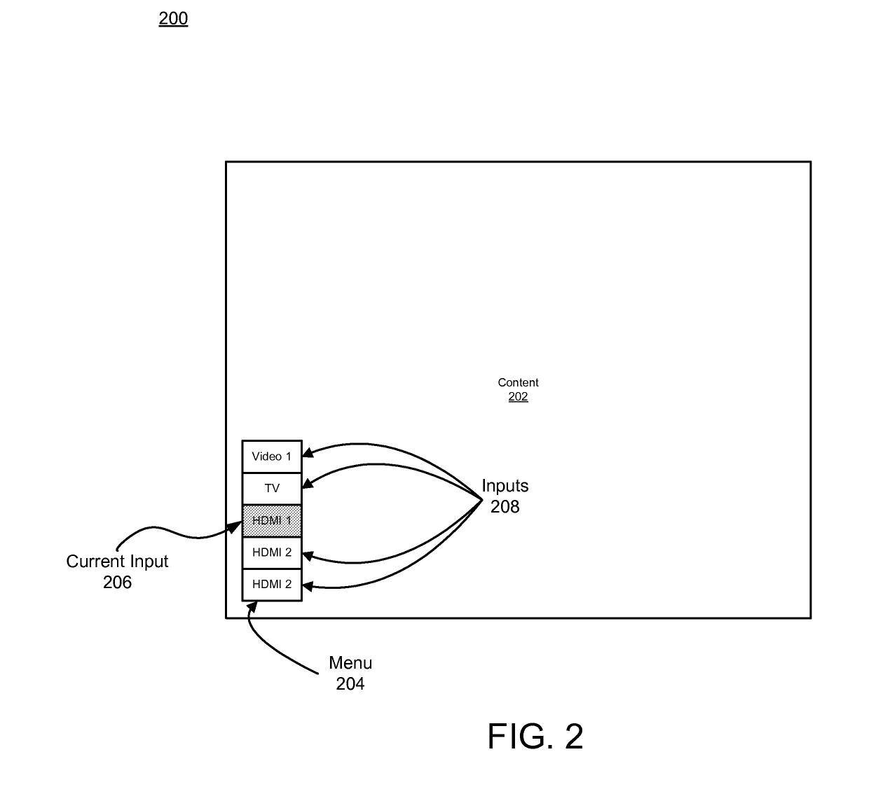

Input area 106 indicates the current signal input. Input area 106 may indicate a plurality of video input types including HDMI (High-Definition Multimedia Interface), DisplayPort, DVI (Digital Visual Interface), VGA, S-video, component, composite, SCART, cable, and satellite, etc. In one embodiment, input area 106 is selectable (e.g., via a remote control device) and allows selection of other inputs via display of a list of the inputs. An exemplary on-screen list of inputs presented by embodiments of the present invention is shown in FIG. 2.

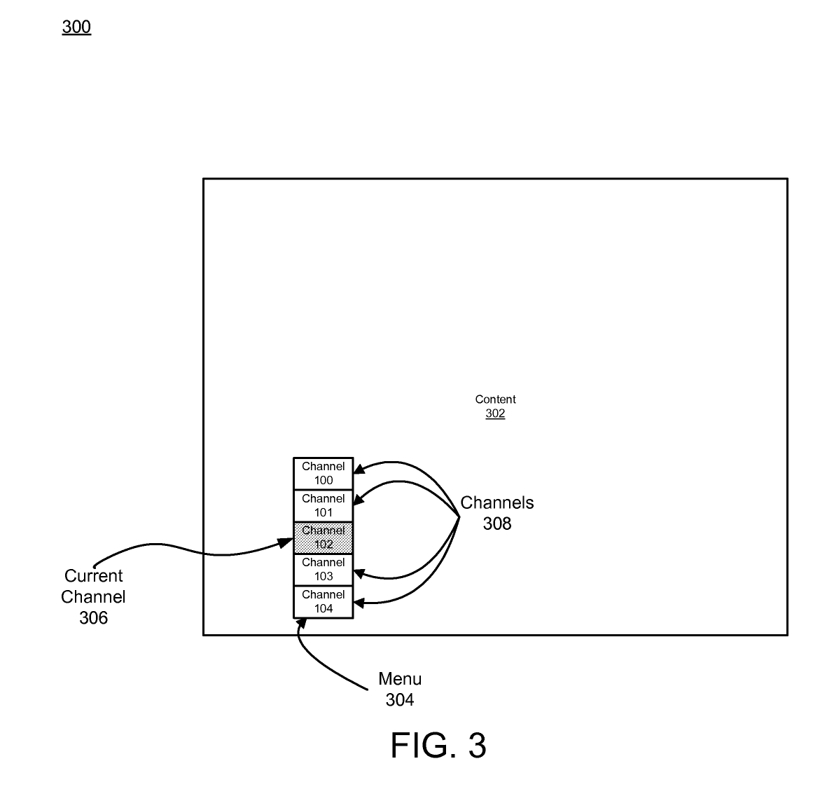

Source area 108 of FIG. 1 indicates the source of the content. Source area 108 is operable to indicate the source of the content displayed in content area 102. In one embodiment, source area 106 is selectable (e.g., via a remote control device) and allows selection of other sources (e.g., DVD or television stations) via display a list of sources. For example, selection of source area 108 invokes the display of a list of television stations which are selectable to change the television station being displayed in content area 102. An exemplary on-screen list of sources presented by embodiments of the present invention is shown in FIG. 3.

Title area 110 of FIG. 1 indicates the title of the content and description area 112 indicates the description of the content that may be displayed in content area 102. In one embodiment, title area 110 and description 112 may be expanded upon selection to show additional information (e.g., additional description or other parts of the title).

Favorite marking area 114 is operable to indicate whether a content source is a user indicated favorite. For example, a television channel may be marked as favorites. Favorite marking area 114 is operable to add a content source to a favorites list upon selection or to remove a content source from a favorites list upon selection.

Zoom mode area 116 indicates the current zoom magnitude applied to content 102. Zoom mode area 116 can be selected and in response a list of zoom mode options (e.g., wide zoom, normal, full, and zoom) are presented for selection. Selection of a zoom mode options changes the zoom mode.

In one embodiment, on-screen closed captioning area 118 upon selection presents a list of one or more closed captioning streams and allows selection of a closed captioning stream. Closed captioning area 118 may further indicate the current closed captioning stream selected. It is noted that embodiments of the present invention thus allow user modification of the closed captioning stream without the user entering general or display device menus.

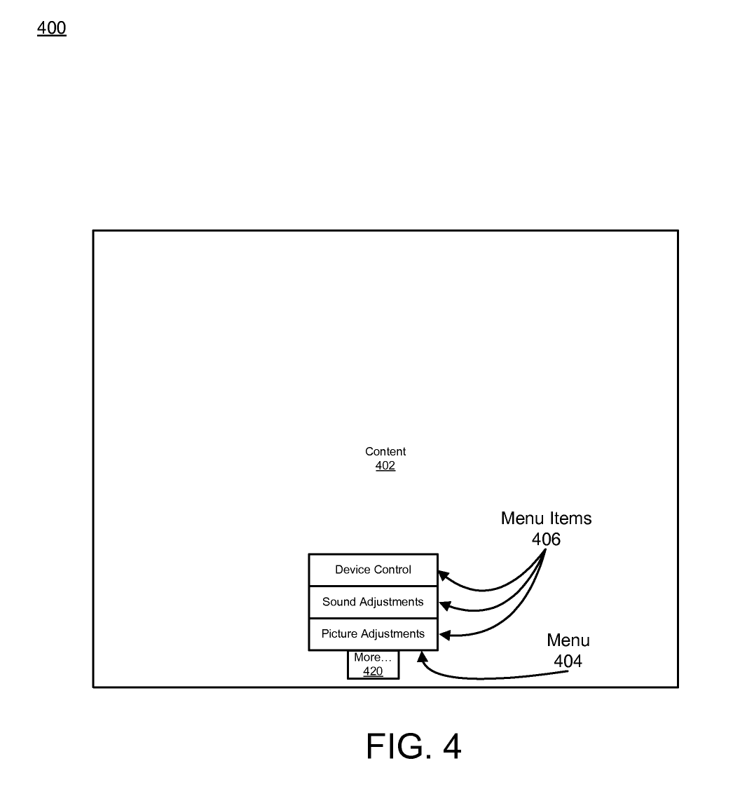

More button 120, upon user selection, presents an on-screen list of additional menus and allows selection of one or more configuration menus of a display device. For example, selection of more button 120 may present a list of additional menus including a sound setting menu and a picture adjustments menu. An exemplary list of additional menus presented by embodiments of the present invention is shown in FIG. 4.

Commerce area 120 allows a user to invoke a function for making purchases or other commerce related functions. For example, invoking the function associated with commerce area 120 may allow a user to purchase applications or music related to the content (e.g., the soundtrack of a television show or movie). It is appreciated that commerce area 120 may allow a user to launch an electronic store (e.g., application store) to purchase a variety of content related things (e.g., posters, music, memorabilia, event tickets, etc.) as well as things unrelated to content.

Ratings area 132 may indicate ratings information and allow configuration of ratings controls (e.g., parental locks or maximum allowed ratings). The ratings information may include a variety of categories including the appropriate audience (e.g., Y (all children), Y7 (older children), Y7 FV (older children—fantasy violence), G (general audience), PG (parental guidance suggested), 14 (parents strongly cautioned), MA (mature audience only)) and content labels (e.g., D (suggest dialogue), L (coarse or crude language), S (sexual situations), V (violence), FV (fantasy violence)).

FIG. 2 shows exemplary components of an on-screen input menu in accordance with one embodiment of the present invention that is invoked by user selection within the banner area 104. Exemplary graphical user interface 200 includes content area 202 and menu 204. In one embodiment, menu 204 is displayed upon selection (e.g., via a remote control) of an area indicating a display device input (e.g., input area 106). It is appreciated that menu 204 may be presented without an interactive banner (e.g., interactive banner 104) or laid over an interactive banner.

Menu 204 includes current input 206 and inputs 208. Menu 204 may be displayed so that current input 206 occupies the same location and space as input area 106. Current input 206 is highlighted indicating that current input 206 is the input currently selected as the input for display of content in content area 202. Inputs 208 are selectable and associated with the other inputs of a display device thereby allowing a user to easily change inputs without having to enter or otherwise navigate on-screen menus or other configuration areas.

FIG. 3 shows exemplary components of an on-screen channel menu in accordance with one embodiment of the present invention and is invoked in response to user selection within interactive banner area 104. Exemplary graphical user interface 300 includes content area 302 and menu 304. In one embodiment, menu 304 is displayed upon selection (e.g., via a remote control device) of an area indicating a content source (e.g., source area 108). It is appreciated that menu 304 may be displayed so that current channel 306 occupies the same location and space as source area 108.

Menu 304 includes current channel item 306 and channels 308 which may include the channel number, television network, and call letters. Current channel item 306 is highlighted indicating that the channel corresponding to channel item 306 is the current source for content area 302. Channel items 308 indicate other channels that can be selected by a user. Menu 304 may also allow a user to navigate through a large number of channels while displaying only a few at a time. It is appreciated that menu 304 allows a user to navigate channels in an efficient manner while still allowing content to be displayed in content 302. It is further appreciated that menu 304 allows a user to change channels without display of an electronic programming guide (EPG) which may obstruct or otherwise substantially reduce the size of the content being displayed.

FIG. 4 shows exemplary components of an on-screen menu for selecting additional menus in accordance with one embodiment of the present invention and is invoked via user selection of a more button, e.g., 120, within the banner area 104. Exemplary graphical user interface 400 includes content area 402, more button 420, and menu 404. Menu 404 may be displayed in response to a user selecting a more button 420 (e.g., more button 120). Menu 404 allows a user to launch various configuration menus via selection of menu items 406. For example, menu items 406 may allow a user to launch a picture adjustments configuration menu, a sound adjustments configuration menu, or a device control configuration menu. It is appreciated that on-screen menu 404 thus allows a user to quickly enter configuration menus (e.g., sound adjustment and picture adjustment) without having to enter or otherwise navigate general configuration menus or scroll through each configuration menu available on a display device.

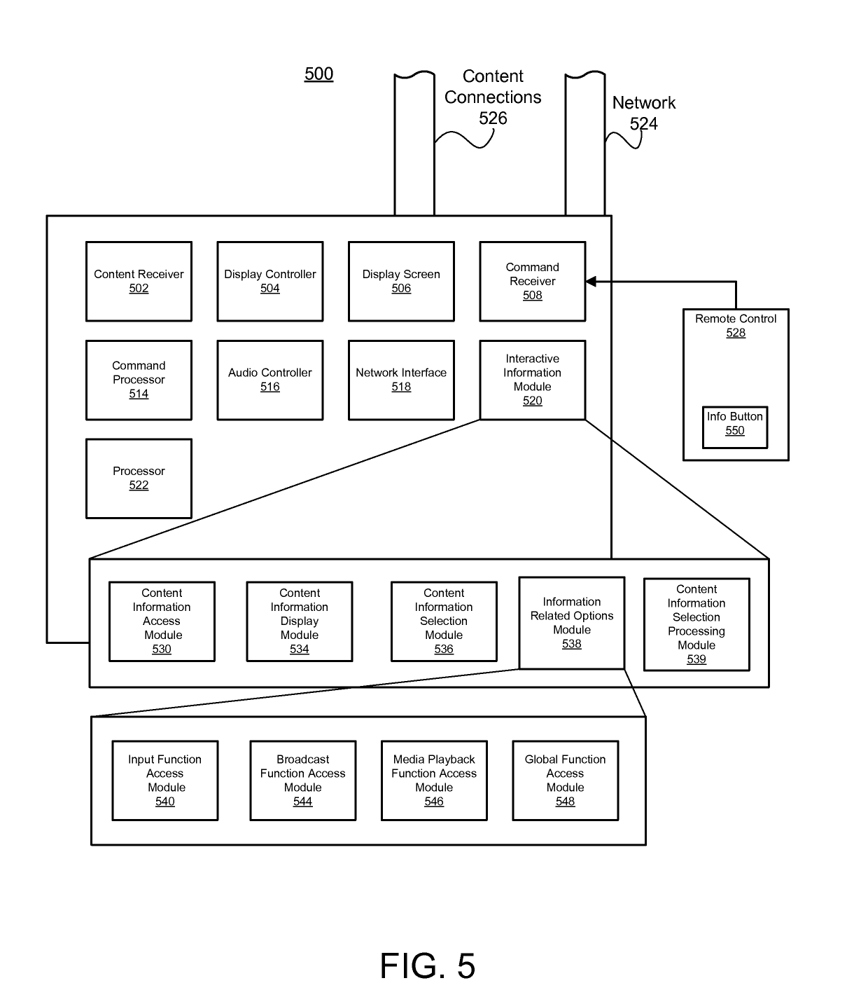

FIG. 5 shows exemplary components of an audio/video display device in accordance with one embodiment of the present invention. System 500 includes content receiver 502, display controller 504, display screen 506, command receiver 508, command processor 514, audio controller 516, network interface 518, interactive information module 520, and processor 522. Processor 522 is operable to execute or otherwise carryout functions of components of system 500.

Content receiver 502 is operable to receive content via content connections 526 and network 524 (e.g., computer network via network interface 518) for system 500. Content receiver 502 may receive signals including content from a variety of sources including, but not limited to, computers, computer networks, portable devices, set top boxes, over the air broadcasts, cable broadcasts, satellite broadcasts, Digital versatile Discs (DVDs), Blu-ray discs, Digital Video Broadcasting—Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 502 may also receive electronic programming guide information. Content connections 526 may include a variety of connection types including HDMI (High-Definition Multimedia Interface), DisplayPort, DVI (Digital Visual Interface), VGA (Video Graphics Array), S-video, component, composite, SCART (Syndicat des Constructeurs d'Appareils Radiorécepteurs et Téléviseurs), cable, and satellite, etc.

Display controller 504 controls display screen 506 of system 500. Display controller 504 may control a variety of display screens types associated with system 500, including CRTs (cathode ray tubes), LCDs (liquid crystal display), plasma displays, projection based, and DLP (digital light processing) displays, etc.

Command receiver 508 receives remote control commands for system 500. Command receiver 508 may receive commands via a variety of technologies including optical receiver and radio frequency. The commands may have been issued via a remote control device (e.g., remote control 528). Command receiver 508 is operable to send the commands to command processor 514 for processing.

Command processor 514 processes commands received from command receiver 508. For example, control codes (e.g., increase volume, change channel, EPG selection, launch an application, launch web browser, etc.) may be received by via an infrared receiver or radio frequency receiver, decoded, processed by command processor 514 or sent to interactive information module 520 for processing.

Interactive information module 520 includes content information access module 530, content information display module 534, content information selection module 536, information related options module 538, and content information selection processing module 539. Content information access module 530 is operable to access a content stream, as described herein, and access various information about the content contained in the content stream (e.g., metadata) and various content related settings and information. For example, content information access module 530 may access rating information, input information, source information, title information, description information, zoom mode information, and closed captioning information. Content information access module 530 provides the information to content information display module 534.

Content information display module 534 is operable to display content information along with content related settings and information. For example, content information display module 534 may display an interactive banner (e.g., interactive banner 104) content and display various information about the content, including the current rating, zoom mode, closed captioning options, input, source, title description, and content rating. In one embodiment, content information display module 534 displays an interactive banner in response to the pressing of information button 550 on remote control 528.

Content information selection module 536 is operable to allow selection of information associated with content (e.g., displayed by content information display module 534). For example, content information selection module 536 allows a user to select (e.g., via a remote or touch interface) various pieces of content related information including rating information, input, source, zoom mode, title, description, closed captioning, favorite, and other settings. Content information selection module 536 provides the selection to content information selection processing module 538.

Information related options module 538 is operable to access and present options associated with information or objects presented with content related information. Information related options module 538 may further include input function access module 540, broadcast function access module 544, media playback function access module 546, and global function access module 548. Input function access module 540 is operable to present menus for changing inputs (e.g., menu 204) and editing input labels.

Broadcast function access module 544 is operable to present menus for selecting and changing various broadcast content settings. For example, broadcast function access module 544 may allow channel changing (e.g., menu 304), editing channel labels, viewing program descriptions (e.g., via a link to the electronic programming guide or other metadata source), parental lock settings (e.g., maximum content rating allowed), channel blocking, selection of alternative audio streams (e.g., different languages), closed captioning settings (e.g., selection of closed captioning streams), and starting or stopping recording of a broadcast.

Media playback function access module 546 is operable to present menus for selection and changing content rendering for a variety of content including music, photos, and internet video/streaming content. For example, media playback function access module 546 may allow content navigation (e.g., go to next/previous piece of content), enabling subtitles, rotating content (e.g., photos or video), turning file protection on/off, entering and exiting slideshow mode, playback control via a playbar (e.g., pause, play, stop, rewind, fast-forward, etc.), adjusting the playback mode (e.g., shuffle and repeat settings), and launching a photomap (e.g., using global positioning system (GPS) of the photo to show the location it was taken on a map).

Global function access module 548 is operable to present menus (e.g., menu 404) for selection changing a variety of settings of system 500. For example, global function access module 548 may allow change volume, muting, picture and sound adjustment, adjusting of wide mode, scene selection (e.g., present picture and sounds settings), launching music search (e.g., analyzing the sound from the content and identifying the song), launching video search (e.g., searching for videos using metadata of the current content), launching an application store to buy related content, adding to/removing content from favorites, rating (e.g., star rating, thumbs up, etc.), sharing content (e.g., recommend or post information about content to social networking sites), and clock adjustment.

Content information selection processing module 539 is operable to receive a selection of options presented via information related options module 538 and perform the associated function. For example, information related options module 538 may present inputs of system 500 and content information selection processing module 539 is operable to process selection of an input and invoke an input changing operation of system 500.

Audio controller 516 controls audio output for system 500 including a variety of outputs including, but not limited to, 2, 2.1, 3.1, 5.1, 6.1, 7.1, and 8.1 channel audio. The audio content may be received via content receiver 502. It is appreciated that audio controller 516 may output to audio equipment integrated within system 500.

FIG. 6 shows exemplary components of an operating environment for presenting interactive information in accordance with one embodiment of the present invention. An exemplary system for implementing embodiments includes a general purpose computing system environment, such as computing system environment 600. Computing system environment 600 may include, but is not limited to a server, desktop computer, laptop, netbook, tablet PC, mobile device, or smartphone. In its most basic configuration, computing system environment 600 typically includes at least one processing unit 602 and memory 604. Depending on the exact configuration and type of computing system environment, memory 604 may be volatile (such as RAM), non-volatile (such as ROM, flash memory, etc.) or some combination of the two.

System memory 604 may include, among other things, Operating System 618 (OS), application(s) 620, and content rendering application 622. Content rendering application 622 is operable to render content (e.g., TV broadcast, cable transmission, satellite, DVD, Blu-ray, music, photo, and internet content). Content rendering application 622 includes interactive content information module 624 which presents information related to the content, as described herein. Interactive content information module 624 further allows selection and presentation of corresponding menus based on the selection of the information related to the content.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 1 by removable storage 608 and non-removable storage 610. Computer storage media includes volatile and nonvolatile, removable and non-removable media implemented in any method or technology for storage of information such as computer readable instructions, data structures, program modules or other data. Memory 604, removable storage 608 and nonremovable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

Computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 612 may allow computing system environment 600 to communication over various networks types including, but not limited to, Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 612 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 600 may also have input device(s) 614 such as a keyboard, mouse, pen, voice input device, touch input device, remote control, etc. Output device(s) 616 such as a display, speakers, etc. may also be included. All these devices are well known in the art and need not be discussed at length here.

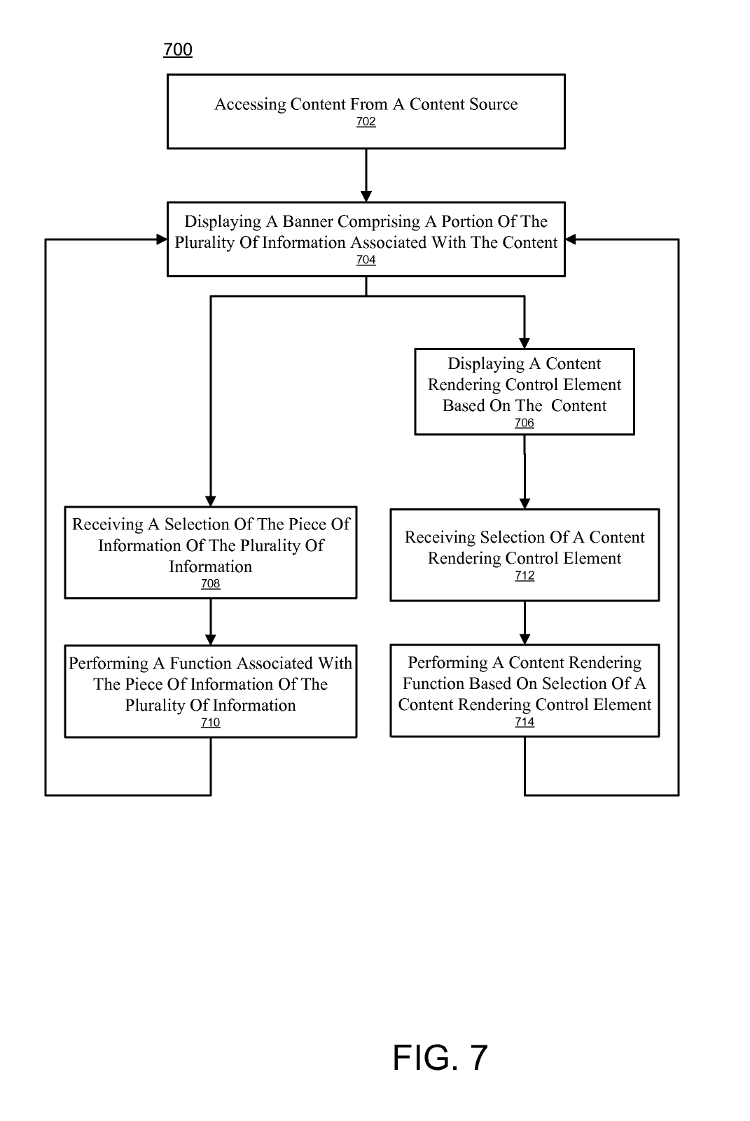

With reference to FIG. 7, flowchart 700 illustrates example functions used by various embodiments of the present invention. Flowchart 700 includes processes that, in various embodiments, are carried out by processors under the control of computer-readable and computer-executable instructions which may be stored on a computer-readable medium. Although specific function blocks (“blocks”) are disclosed in flowchart 700, such steps are examples. That is, embodiments are well suited to performing various other blocks or variations of the blocks recited in flowchart 700. It is appreciated that the blocks in flowchart 700 may be performed in an order different than presented, and that not all of the blocks in flowchart 700 may be performed.

FIG. 7 shows a flowchart of an exemplary computer controlled process 700 for presenting interactive information in accordance with one embodiment of the present invention. Process 700 allows user modification of settings without the user having to enter or otherwise navigate menus or other general display device menus.

At block 702, content is accessed from a content source. As described herein, the content may be accessed for display on a display device (e.g., system 500).

At block 704, a banner area is displayed with information associated with the content and having user selectable screen items. For example, the user selectable items may allow the user to adjust zoom controls, select a closed captioning stream, change the language, invoke an electronic store interface (e.g., to buy applications, audio or video media, software, additional content, etc.), and adjust ratings controls (e.g., parental rating locks). As described herein, a portion of content area may be used to display information associated with the content. The banner may be displayed while the content is being shown, prior to display of the content, or after the content has been displayed.

At block 706, a content rendering control element is displayed based on the content. As described herein, controls for playback of the content may be displayed along with the information associated with the content.

At block 708, a selection of a piece of information is received in response to a user selecting a display element. As described herein, information associated with the content is displayed in an interactive manner such that the information is selectable.

At block 710, a function associated with the piece of information associated with the content is performed. As described herein, on-screen menus may be directly presented and options selected which correspond to functions of the display device.

At block 712, selection of a content rendering control element is received. As described herein, content rendering control elements (e.g., play button, zoom mode, etc.) and information associated with the content may be selectable. For instance, a television setting change may be made, etc.

At block 714, the content rendering function associated with the content rendering element is performed.

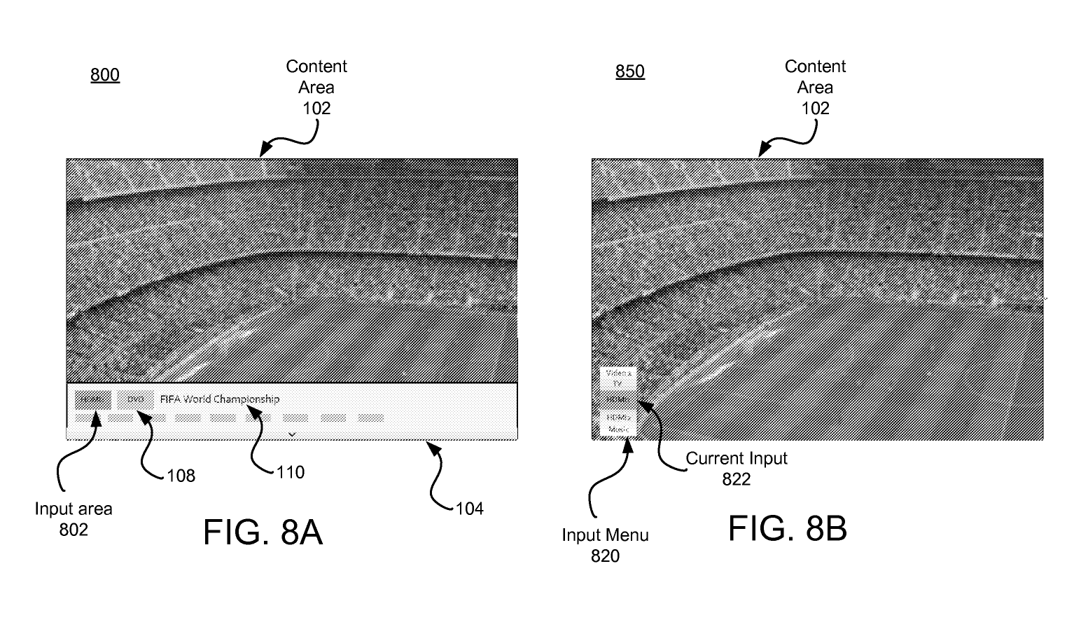

FIGS. 8A, 8B, 9A, 9B, 10A, 10B, 10C, 11A, 11B, and 11C show exemplary on-screen display areas, in accordance with an embodiment of the present invention. FIG. 8A shows an exemplary on-screen display area 800, in accordance with one embodiment. On-screen display area 800 includes content area 102, banner 104, source area 108, title area 110, and input area 802. Input area 802 indicates that the current input corresponding to the content shown in content area 102 (e.g., HMDI1). As shown, the input area 802 is highlighted indicating that input area 802 is the currently selected area of banner 104. Upon invoking the function associated with input area 802 (e.g., via a remote control button), on-screen display area 850 of FIG. 8B may be displayed.

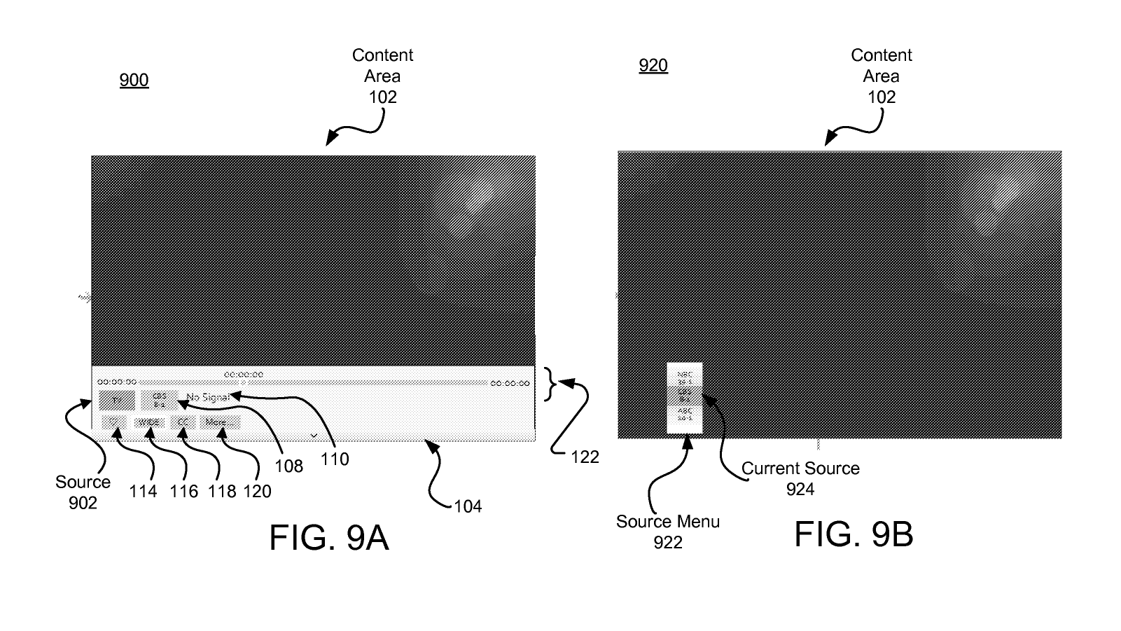

FIG. 8B shows an exemplary on-screen display area 850, in accordance with one embodiment. On-screen display area 850 includes input menu 820, current input 822, and content area 102. Input menu 820 comprises an on-screen list of inputs (e.g., Video 1, TV, HDMI1, HDMI2, and Music) which are user selectable. As shown, current input 822 is highlighted indicating the current input is HDMI1. Upon selection of a “TV” input (e.g., via a remote control button), on-screen display area 900 of FIG. 9A may be displayed.

FIG. 9A shows an exemplary on-screen display area 900, in accordance with one embodiment. On-screen display area 900 includes content area 102, banner 104, favorite button 114, zoom mode area 116, closed captioning area 118, more button 120, title area 110, source 108, progress bar 122, and source area 902. As shown, source area 902 is highlighted indicating that source area 902 is selected. In one embodiment, content area 102 is blank upon selection of certain inputs (e.g., TV or Music) until a source is selected via source area 108. Upon selection of a source via source area 108 (e.g., via a remote control), on-screen display area 920 of FIG. 9B may be displayed.

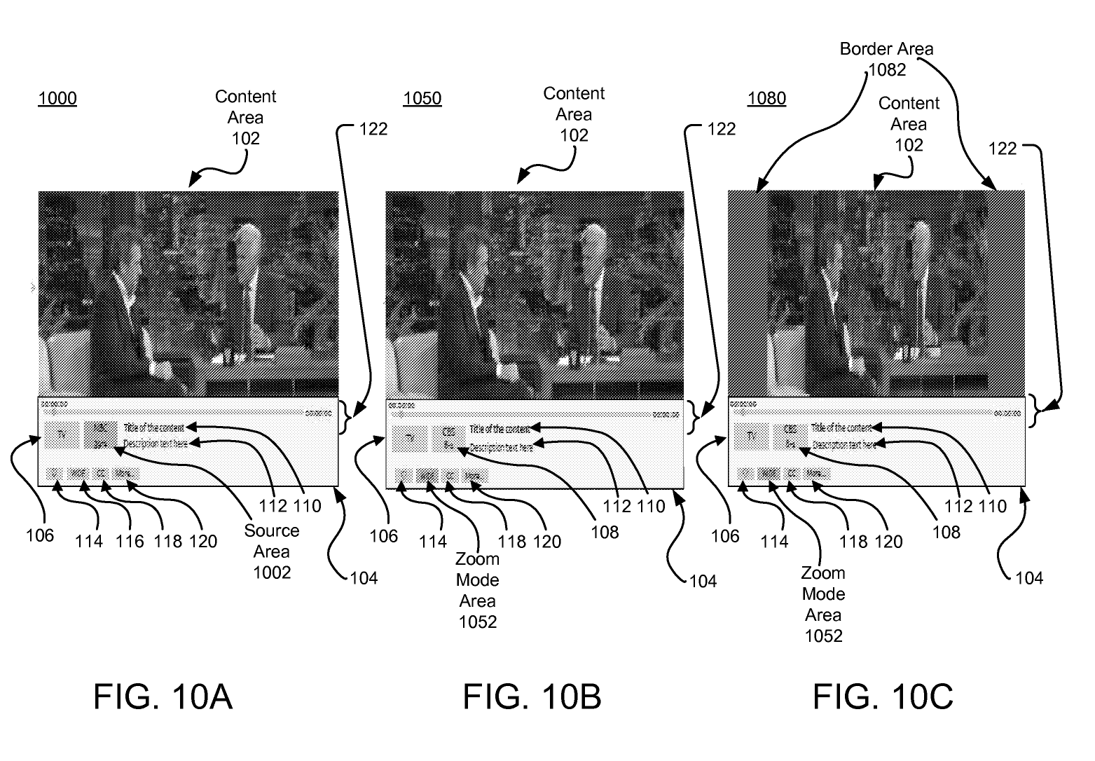

FIG. 9B shows an exemplary on-screen display area 920, in accordance with one embodiment. On-screen display area 920 includes content area 102, source menu 922, and current source 924. Source menu 922 comprises an on-screen list of sources (e.g., channels such as NBC 39-1, CBS 8-1, and ABC 10-1) which are user selectable. Current source 924 is highlighted indicating the currently selected source (e.g., CBS 8-1). In one embodiment, content area 102 is blank while source menu 922 is navigated by a user after selection of certain inputs (e.g., TV or Music) until a source is selected. Upon selection of a source (e.g., channel selection via a remote control button), on-screen display area 1000 of FIG. 10A may be displayed.

FIG. 10A shows an exemplary on-screen display area 1000, in accordance with one embodiment. On-screen display area 1000 includes content area 102, banner 104, input area 106, favorite button 114, zoom mode area 116, closed captioning area 118, more button 120, progress bar 122, description area 112, title area 110, and source area 1002. As shown, source area 1002 is highlighted indicating that source area 1002 is selected and a source menu (e.g., source menu 924) may be invoked. Content area 102 displays content corresponding to the source indicated by source area 1002 (e.g., NBC 39-1). A user may then navigate around banner 104 and select other areas of banner 104. For example, a user may navigate around to select zoom mode are 116 and on-screen display area 1050 of FIG. 10B is displayed.

FIG. 10B shows an exemplary on-screen display area 1050, in accordance with one embodiment. On-screen display area 1050 includes content area 102, banner 104, input area 106, source area 108, favorite button 114, closed captioning area 118, more button 120, progress bar 122, description area 112, title area 110, and zoom mode area 1052. As shown, zoom mode area 1052 is highlighted indicating that zoom mode area 1052 is selected and a zoom related functions or menus may be invoked. In one embodiment, zoom mode area 1052 is an on-screen button operable for toggling between zoom modes. In an exemplary embodiment, upon invoking the function associated with zoom mode area 1052, on-screen display area 1080 of FIG. 10C may be displayed.

FIG. 10C shows an exemplary on-screen display area 1080, in accordance with one embodiment. On-screen display area 1050 includes content area 102, banner 104, input area 106, source area 108, favorite button 114, closed captioning area 118, more button 120, progress bar 122, description area 112, title area 110, and zoom mode area 1052, and border area 1082. As shown, border area 1082 is present due to a change in the zoom mode (e.g., normal mode for 4:3 aspect ratio content) due to toggling of the zoom mode via zoom mode area 1052.

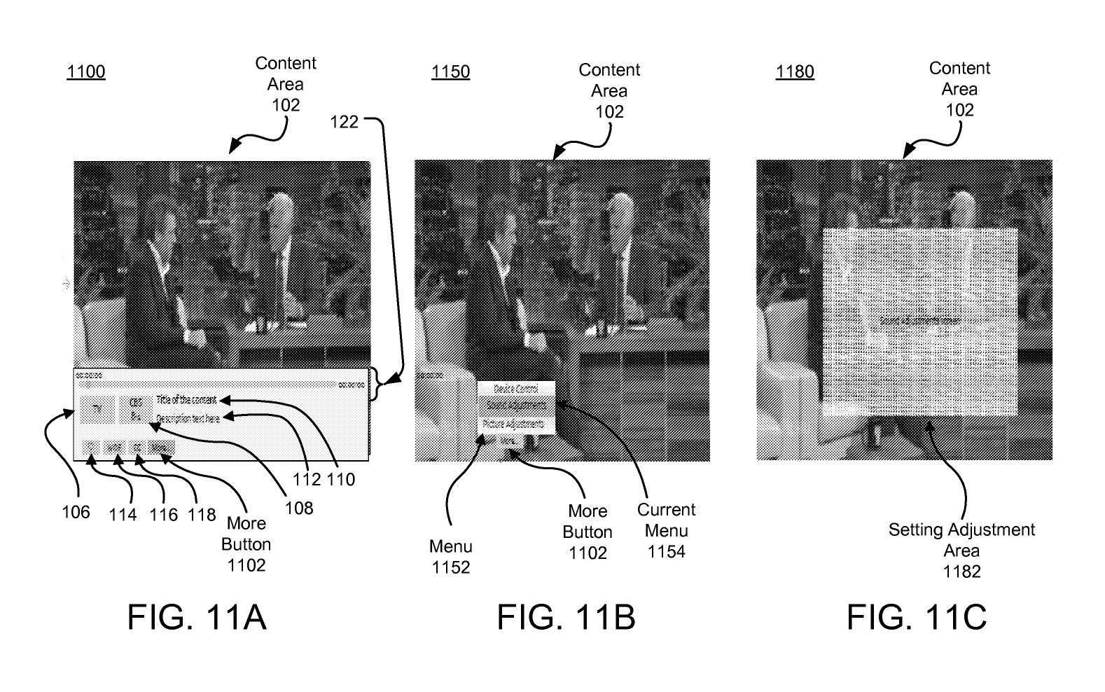

FIG. 11A shows an exemplary on-screen display area 1100, in accordance with one embodiment. On-screen display area 1100 includes content area 102, banner 104, input area 106, source area 108, favorite button 114, closed captioning area 118, progress bar 122, description area 112, title area 110, and zoom mode area 1052, and more button 1102. As shown, more button 1102 is highlighted indicating that more button 1102 is selected and additional options, functions (e.g. via additional menus) or menus may be invoked. Upon invoking more button 1102, on-screen display area 1150 of FIG. 11B may be displayed.

FIG. 11B shows an exemplary on-screen display area 1150, in accordance with one embodiment. On-screen display area 1150 includes content area 102, menu 1152, more button 1102, and current menu 1154. In one exemplary embodiment, menu 1152 comprises a device control item, sound adjustments item, and picture adjustments items. Menu 1154 is displayed upon selection and invoking the function associated with more button 1102. As shown, current menu 1154 is highlighted indicating that a menu (e.g., sounds adjustments) that can be invoked upon selection by a user (e.g., via a remote control). Upon selection of current menu 1154 (e.g., via a remote control, on-screen display area 1180 of FIG. 11C may be displayed.

FIG. 11C shows an exemplary on-screen display area 1180, in accordance with one embodiment. On-screen display area 1180 includes content area 102 and setting adjustment area 1182. Setting adjustment area 1182 allows a user to change various settings of an audio/video display device. In one exemplary embodiment, setting adjustment area 1182 is a sound adjustment screen invoked via a sound adjustments menu of a menu (e.g., menu 1152). Setting adjustment area 1182 may overlay content area 102.

In this fashion, embodiments of the present invention provide an interactive banner with information related to the content which is selectable to directly facilitate access to functions associated with the information related to the content. Easy access is thus provided to display device settings and other content rendering settings without having to enter and navigate general menus. Embodiments of the present invention further eliminate the need for direct access remote control keys as functions are available via the interactive banner. Embodiments of the present invention also provide a more consistent user expectation for where to perform settings changes instead of having to determine which button to press on a remote control.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A media device implemented method for interactively presenting content related information comprising:
accessing content from a content source, wherein said content source comprises a plurality of information associated with said content;
displaying a banner comprising a portion of said plurality of information, wherein a piece of said plurality of information associated with said content is user selectable;
receiving a user selection of said piece of information of said plurality of information associated with said content; and
performing a function on said media device associated with said piece of information of said plurality of information associated with said content.

2. The method of claim 1 wherein said banner overlays said content during playback of said content.

3. The method of claim 1 wherein said banner is automatically displayed upon said content being initially accessed.

4. The method of claim 1 wherein said function is operable to store a channel as a favorite.

5. The method of claim 1 wherein said function is operable to display a list of a plurality of channels.

6. The method of claim 1 wherein said function is operable to display a list of a plurality of inputs, wherein each of said plurality of inputs is selectable.

7. The method of claim 1 wherein said function is operable to display a list of a plurality of closed captioning streams, wherein each of said plurality of closed captioning streams is selectable.

8. The method of claim 1 wherein said function is operable to allow selection of one of a plurality of audio streams.

9. A system for interactive presentation of content related information comprising:
a content information access module operable to access information associated with a piece of content;
a content information display module operable to the display said information associated with said piece of content;
a content information selection module operable to receive a selection of information associated with said piece of content; and
a content information selection processing module operable to perform a function associated with said selection of information associated with said piece of content.

10. A system as described in claim 9 wherein said content information display module displays said information associated with said piece of content in a banner region.

11. A system as described in claim 9 wherein said function is operable for receiving a selection of one of a plurality of display device inputs.

12. A system as described in claim 9 wherein said function is operable for receiving a selection of one of a plurality of channels.

13. A system as described in claim 9 wherein said function is operable for receiving a selection of a parental rating threshold.

14. A system as described in claim 9 wherein said function is operable for receiving a selection of a configuration menu.

15. A computer readable media comprising instructions that when executed by an electronic system implement a method for interactively displaying content related information, said method comprising:
accessing content from a content source, wherein said content source comprises a plurality of information associated with said content;
displaying said content and contemporaneously displaying a banner comprising a portion of said plurality of information, wherein a piece of said plurality of information associated with said content is selectable;
receiving a selection of said piece of information of said plurality of information associated with said content; and
performing a function associated with said piece of information of said plurality of information associated with said content.

16. The computer readable media of claim 15 wherein said banner overlays content during playback.

17. The computer readable media of claim 15 wherein said banner is automatically displayed upon accessing said content.

18. The computer readable media of claim 15 wherein said function is operable for receiving a selection of one of a plurality of inputs of a display device.

19. The computer readable media of claim 15 wherein said function is operable for receiving selection of a configuration menu.

20. The computer readable media of claim 15 wherein said function is operable to store a channel as a favorite.
